(19) United States
(12) Patent Application Publication
(10) Pub. No.: US 2026/0036494 A1
(43) Pub. Date: Feb. 5, 2026

(54) DEVICE AND SYSTEM FOR TESTING AND CERTIFICATION OF PULLING SWIVELS

(71) Applicant: Tallman Equipment Co., Columbus, IN (US)

(72) Inventors: Edward F. Youngerman, St. Charles, IL (US); Andrew F. Finn, Elmhurst, IL (US); Sara E. Hassell, Oakbrook Terrace, IL (US); Sean P. Galligar, Cary, IL (US)

(73) Assignee: Tallman Equipment Co., Columbus, IN (US)

(21) Appl. No.: 18/790,742

(22) Filed: Jul. 31, 2024

(51) Int. Cl. G01M 99/00

(52) U.S. Cl. CPC G01M 99/007

(57) ABSTRACT

Systems and methods for testing and certifying swivels such as are used for line and cable pulling are disclosed. The disclosed systems and methods for testing and certification may be used to ensure the tested swivels are still suitable for use in industrial settings. Devices for performing the described testing procedures are also disclosed herein.

### FIELD

The claimed technology relates generally to testing industrial equipment and more particularly to systems and methods for testing and certifying swivels such as are used for line and cable pulling.

### BACKGROUND

Industries which utilize heavy cables such as power transmission and lifting/rigging all typically use swivels in applications where a cable may be subjected to both tension (pulling) forces as well as torsion (twisting) forces. Employing swivels may help minimize twisting of cables during installation, as they allow the line to rotate slightly around its axis without transmitting the twist further down the line. Such swivels typically include a central body portion pivotably connected to two end portions. Each end portion includes an attachment feature such as a pin to allow the swivel to be attached to one or more cables. A gap may be present between the central body portion and each end. When subjected to a tension load the swivel is designed to allow one or both of the end portions to rotate when subjected to torque, typically applied by an attached cable which tries to twist.

High-tension power transmission and distribution lines are typically run from one tower to the next by pulling one conductor cable off of a large spool or drum joined to another cable or high tensile rope by a swivel. Pulls of over 1 km are not uncommon in the power transmission industry in rural areas which might generate thousands of Newtons of tension on the cables as well as on the swivel. Additionally, as the conductor cable or rope is pulled linearly it also twists creating torsional forces which can cause the conductor cable and/or rope to break. The sudden failure of heavy cables under such high tension can be extremely dangerous to workers and equipment.

Swivels used in such applications must be able to readily rotate in response to torque applied by the cable being pulled while under very high tension. Over time, these swivels can sometimes degrade in performance and lose their ability to rotate when subjected to torque while under tension. Differentiating between good and potentially failing swivels can be difficult, especially because a swivel may behave normally under no or lower tension loads but resist or even stop rotating altogether when subjected to higher tension loads normally associated with long runs of cable.

That is, a swivel may pass a visual inspection and even appear to operate normally at the beginning of a pull only to fail catastrophically once a higher tension load is applied, potentially through failure of the swivel itself but more commonly due to failure of an attached cable which is caused to twist when the swivel fails to rotate. What is needed are strategies for testing swivels to determine if they still can be used at a predetermined safety threshold.

### SUMMARY

In one aspect methods of testing an industrial swivel include applying a first tension force to the swivel being tested, applying a first rotational force to the swivel thereby causing the swivel to rotate in a first direction, increasing the tension force on the swivel to a second tension force over a first period of time, maintaining the second tension force and first rotational force on the swivel for a second period of time, ceasing the first rotational force and applying a second rotational force to the swivel, maintaining the second tension force and second rotational force in the second direction on the swivel for a third period of time, and reducing the tension force on the swivel to the first tension force over a fourth period of time. The first tension force may be equal to 10% of the rated working load of the swivel being tested and the second tension force equal to 125% of the rated working load of the swivel being tested. The first, second, third, and fourth periods of time may be equal, and each may be one minute in duration. The first rotational force and the second rotational force may cause the swivel to rotate in opposite directions and such forces may cause the swivel to rotate at a speed of 10 rpm. Optionally, after reducing the tension force on the swivel to the first tension force over a fourth period of time the second rotational force to the swivel may be ceased, and then the tension force may be reduced to zero. After testing the swivel may be marked with indicia relating to the test, and if the swivel ceases to rotate and/or requires torque which exceeds a predetermined threshold when subjected to the first rotational force or the second rotational force the indicia may indicate failure of the test.

In another aspect a method of testing a swivel is disclosed, including mounting a swivel in a testing apparatus, selecting test parameters, applying a first tension force to the swivel, applying a first rotational force to the swivel causing the swivel to rotate, increasing the tension force on the swivel to a second tension force over a first period of time, maintaining the second tension force and first rotational force on the swivel for a second period of time. The swivel fails the testing procedure if it ceases rotation or if it exceeds a predetermined torque threshold during the first or second period of time. Further, a second rotational force is applied to the swivel, maintaining the second tension force and second rotational force in the second direction on the swivel for a third period of time, where the swivel fails the testing procedure if it ceases rotation or if it exceeds a predetermined torque threshold during the third period of time. The method still further includes reducing the tension force on the swivel to the first tension force over a fourth period of time where the swivel fails the testing procedure if it ceases rotation or if it exceeds a predetermined torque threshold during the fourth period of time. The method may also include ceasing the second rotational force on the swivel when the first tension force is reached, reducing the tension force on the swivel to zero, and marking the swivel with a certification mark relating to the test. After completion of the test sequence the certification mark and/or data corresponding to the certification mark may be entered into a database. The first, second, third, and fourth periods of time may be equal and the first and second rotational forces may be in opposite directions.

In a further aspect a test platform for testing swivels includes a testing assembly having a first portion and a second portion connected by at least one support member and defining a testing volume between the first portion and the second portion, the first portion having a hydraulic cylinder configured to apply tension forces and operationally connected to a fixed upper connection member having a first swivel attachment point disposed within the testing volume, and the second portion having a drive system operationally connected to a rotatable driveshaft, the rotatable driveshaft being operationally connected to a second swivel attachment point disposed within the testing volume, and the drive system being configured to apply rotational forces to the rotatable driveshaft. A torque transducer may be disposed between the drive system and the rotatable driveshaft configured to measure torque applied by the drive system to the rotatable driveshaft. The drive system may include a hydraulic and/or electric motor. The test platform may optionally include one or more universal joints between the rotatable driveshaft and the second swivel attachment point. A controller device having a display, a memory, a processor, and an input interface may be operationally attached such that the controller is operationally connected to the drive system and the hydraulic cylinder. The controller device may be configured to control the rotational forces applied by the drive system to the rotatable driveshaft and the tension forces applied by the hydraulic cylinder to the upper connection point. The controller may also be configured to receive information from the torque transducer relating to torque applied by the drive system to the rotatable drive shaft. The first swivel attachment point and the second swivel attachment point may be removable and/or configured for attachment to a specific style/make/model/brand of swivel.

In still another aspect, an apparatus for testing a line pulling swivel is provided including a testing assembly having a first portion and a second portion connected by a plurality of support members and defining a testing volume between the first portion, the second portion, and the plurality of support members, the first portion having a hydraulic cylinder operationally connected to and configured to apply tension forces to an upper connection member, and a first swivel attachment point disposed within the testing volume and connected to the upper connection member, the second portion having a drive system rotatably connected to a rotatable driveshaft and configured to selectively apply rotational forces to the driveshaft, a second swivel attachment point disposed within the testing volume and connected to the driveshaft, and where the upper and second swivel attachment points are configured for attaching to a line pulling swivel. A controller device having a display, a memory, a processor, and an input interface may also be operationally connected to the drive system and/or hydraulic cylinder and configured to control the rotational and tension forces applied to the driveshaft. The controller may also be configured to monitor the torque, tensile forces, testing time, system pressure, and/or driveshaft position. The controller may be configured to receive information from the torque transducer relating to torque applied by the drive system to the driveshaft.

In still another aspect an apparatus for testing swivels having a linear actuator with an attachment point and configured to apply tension force to a swivel attached to the linear actuator attachment point, a rotational actuator having an attachment point and configured to apply torque to a swivel attached to the rotational actuator attachment point, a swivel operationally attached to the linear actuator attachment point and the rotational actuator attachment point, and a controller operationally connected to the linear actuator and the rotational actuator and configured to measure the tension force applied to the swivel by the linear actuator and to measure the torque applied to the swivel by the rotational actuator. The controller may be further configured to signal a failure code for a swivel being tested if the swivel ceases rotating when the rotational actuator is applying torque and the linear actuator is applying tension. The controller may also be configured to signal a failure code if the controller detects an applied torque exceeding a predetermined threshold such as to cause the swivel being tested to rotate.

### BRIEF DESCRIPTION OF THE DRAWINGS

FIG. 1 is a perspective view of a swivel;

FIG. 2 is a perspective view of a swivel testing device according to one embodiment;

FIG. 3 is a perspective view of a portion of the device shown in FIG. 2;

FIG. 4 is a perspective view of a portion of the device shown in FIG. 2;

FIG. 5 is a flowchart of a swivel testing procedure according to one embodiment;

FIG. 6 is an example test report of a passed swivel test;

FIG. 7 is an example test report of a failed swivel test; and

FIG. 8 is a perspective view of a controller according to one embodiment.

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

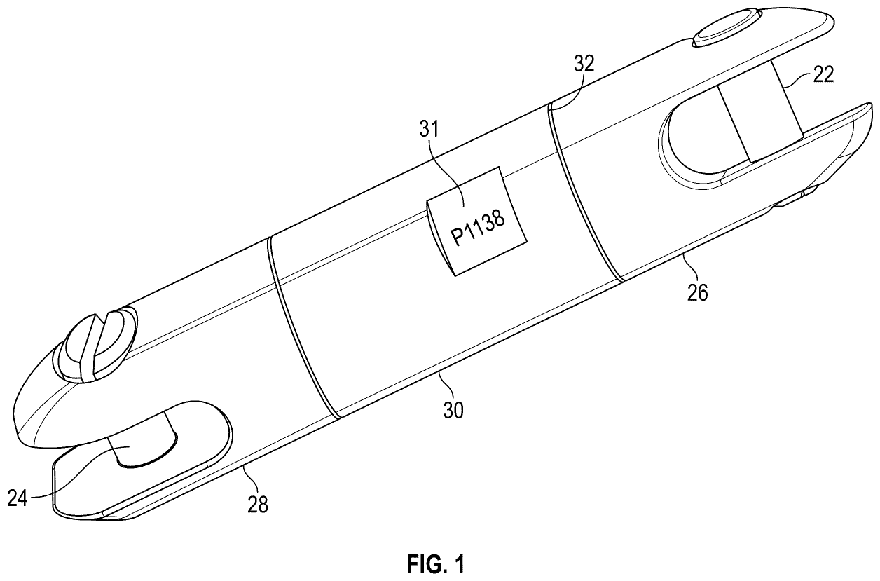

Swivels 20 such as the example shown in FIG. 1 are typically used in applications where a cable may be subjected to both tension (pulling) forces as well as torsion (twisting) forces. Swivel 20 includes a central body portion 30 connected to two end portions 26, 28. Typically one of the end portions 26, 28 is configured to rotate while the other is fixed. For example, end portion 26 might be pivotably connected to body portion 30 while end portion 28 is fixed to body portion 30 (i.e., is prevented from rotating relative to the body portion). Each end portion includes an attachment feature 22, 24 shown in this example as a pin, but in other examples different attachment features may be used on one or both ends. A gap 32 is present between the central body portion 30 and the pivoting end (in this example, end 26). When subjected to tension the gap 32 may increase temporarily. One sign of wear is that the gap 32 fails to return to its pre-tension size when a tension load is removed. Another sign of swivel wear or otherwise performance degradation is when the pivotable end portion fails to pivot, or fails to pivot smoothly, when swivel 20 is subjected to a tension load. In a practical implementation, swivels may undergo testing for various reasons, such as to verify functionality and/or durability under different applications. Such tests may allow a user to test desired parameters and apply various parameters to a swivel and indicate a fail if a swivel does not meet a predetermined requirement, discussed further herein.

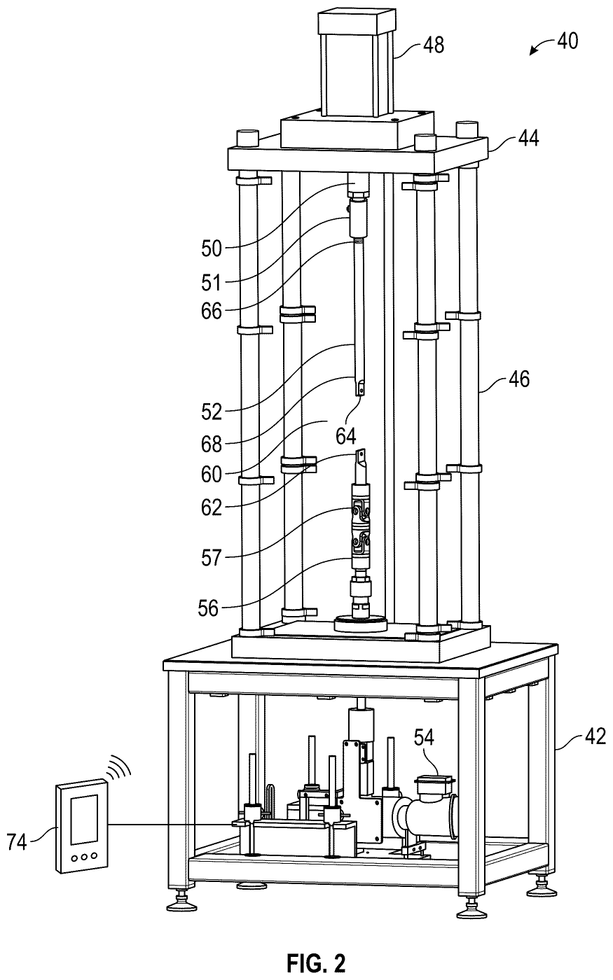

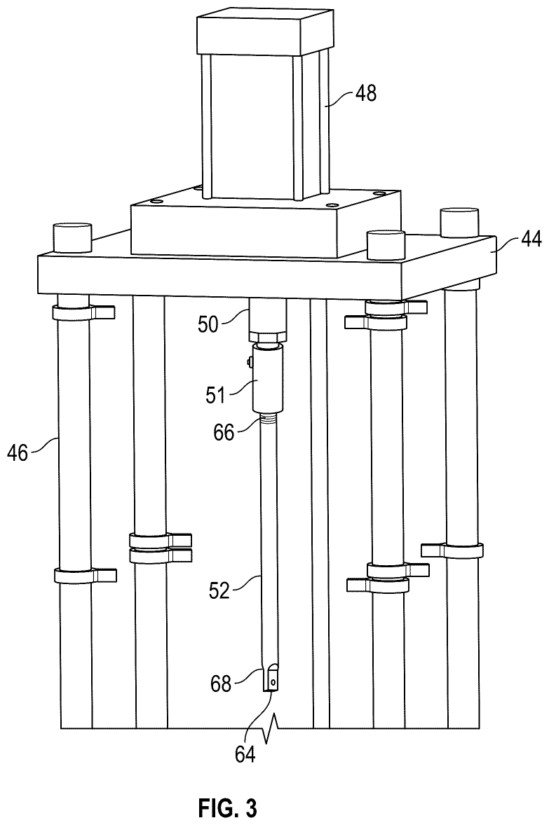

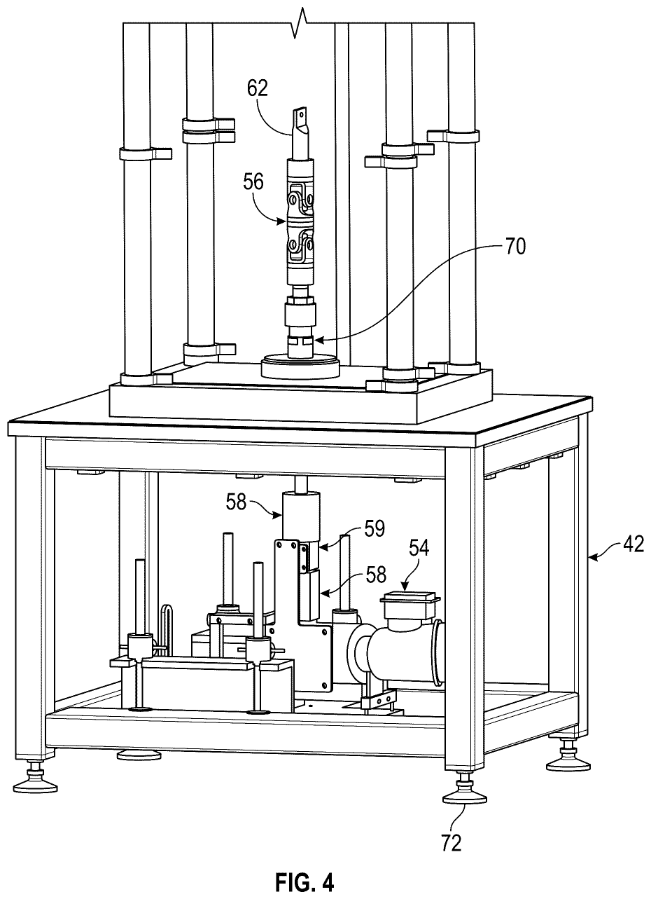

One example of a testing assembly suitable for performing the methods of testing swivels described herein is shown in FIG. 2-4. In this particular example, the testing assembly 40 includes a first portion 44 (shown in greater detail in FIG. 3) and a second portion 42 (shown in greater detail in FIG. 4) operationally connected by one or more support members 46. As illustrated, the support members 46 are of a fixed length so as to space the first portion 44 at a predetermined distance from the second portion 42. In other examples, the support members may be adjustable in length and/or the position of the first portion on the support members may be adjustable so as to allow for the distance between the first and second portions to vary. It should be appreciated that alternative strategies for support members are within the scope of the present description, provided there is a distance maintained between the first portion and second portion. The support members 46 define a testing volume 60 between the first and second portions.

Optionally, the testing volume 60 may be contained within an enclosure (not shown) suitable for reducing the risk of injury or equipment damage in the event of a catastrophic failure by a swivel during a testing procedure. Such enclosure may be made from any suitable material such as metal, impact-resistant polycarbonate, and the like.

Disposed within the testing volume 60 is a first connection member 50 which is operationally connected to the first portion 44, a force transducer 51, and an extension member 52 which includes a first attachment point 64 such as a hook, eye, or other connecting mechanism. Also disposed within the testing volume 60 is a second connection member 56 which is operationally connected to the second portion 54 and includes a second attachment point 62. In one example, the first connection member 50 is designed for pulling by applying a tension force in a linear direction, while the second connection member is designed for rotating around an axis by applying a rotational force, facilitating circular moving or turning. In another example, the first connection member 50 and/or the second connection member 56 include universal joints which allow for a swivel to have some horizontal drift or “wobble” while rotating during a testing sequence while maintaining tensile force applied to the swivel along the central axis of the swivel. In yet another example, the second connection point 56 includes an additional universal joint 57. The exact configuration of the first attachment point 64 and the second attachment point 62 may vary according to the style and configuration of the swivel being tested.

In one example, the attachment points are removable so one testing apparatus may be configured to test more than one style of swivel. In another example the first attachment point 64 and second attachment point 62 are paired for a specific swivel model, type, and/or size so they may easily be selectively mounted to the testing apparatus according to the type of swivel being tested. Optionally, extension members 52 may be used to allow for swivels of different sizes and/or having different attachment portions to be mounted and tested. Extension members may have different lengths, diameters, and/or attachment features to allow for variations in swivel design. The extension member 52 includes a proximal end 66 configured for attachment to the first connection member 50 and a distal end 68 configured to include an attachment point 64. Attachment points may vary in length, diameter, and shape so as to be compatible with different makes/models/styles of swivel. In another example, the extension members are configured for attachment to the second connection member rather than the first connection member. In yet another example, an actuator may be configured to further include attachment points as further discussed herein.

The second portion 42 of the testing assembly 40 includes a drive system 54, which may include a motor configured to apply torque through one or more coupling members 58 to a rotatable driveshaft 70 operationally connected to the second connection member 56. A torque transducer 59 is disposed such that it may measure the torque provided by the drive system 54 and applied to the swivel being tested through the drive shaft 70. A torque transducer as contemplated herein includes any electrical, mechanical, or electro-mechanical mechanism for monitoring torque including virtual sensors and estimation mechanisms.

The drive system may also include a transfer case/gearing assembly operationally disposed between the motor and the drive shaft 70 configured to modify the rotational force transmitted from between the motor and the swivel 20 being tested. The motor within the drive system 54 may be an electric motor, a hydraulic motor and pump, or any other suitable mechanism capable of generating sufficient rotational force. The second portion 42 may further include one or more stabilizing and leveling members 72 such as adjustable feet to allow for the testing assembly 40 to be leveled on a support base such as a floor or workbench. Optionally, the second portion 42 may further include one or more leveling indicators such as a spirit level or leveling sensors. Such sensors may further be operationally connected to a control device 74 (described below), and a check to confirm the testing assembly is level may be performed by such control device upon initiation of a testing sequence. The first portion 44 of the testing assembly 40 includes a hydraulic system 48 having a cylinder shaft or rod (not shown) operationally connected to the first connection member 50. The hydraulic cylinder 48 or other linear actuator is configured to apply tensile force to the swivel during a testing procedure which may be measured by the force transducer 51 or by any other suitable means.

A control device 74 is operationally connected to the sensors and controllers on the testing assembly 40 either by a physical, hard-wired connection or wirelessly. The control device may be a purpose-built device having a processor, memory, and wired/wireless communication capability which is optionally mounted to or near the testing assembly 40. Alternatively, the control device 74 may be a computer, mobile device (phone or tablet) or other suitable device capable of running operational and control software for the testing assembly 40. The control device 74 may be configured to control the rotational and tension forces applied to a swivel during testing. The functionality of such control devices is discussed in greater detail below with respect to the disclosed methods of testing and certifying swivels.

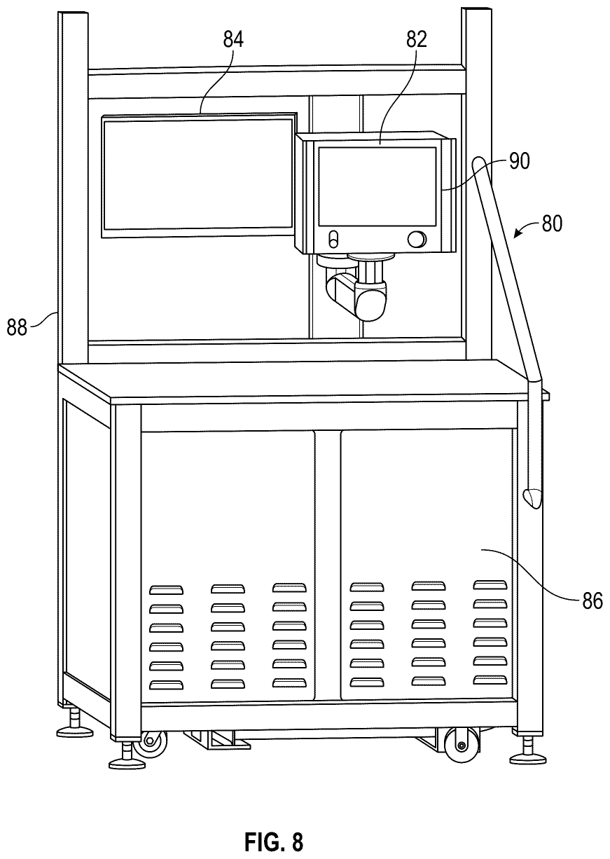

An alternative control device 80 is shown in FIG. 8. In this particular example the control device 80 is housed in a movable cabinet 88 which holds the human-machine interface 82 which includes a computer 84 (having a processor, memory, storage, and wireless and/or wired data transmission components) as well as a touchscreen interface/display 90. The cabinet 88 may also house a hydraulic pump and reservoir as in a housing 86 for providing a testing apparatus such as those disclosed herein with pressurized hydraulic fluid. Optionally, the cabinet may also include equipment for providing electrical power to a testing apparatus.

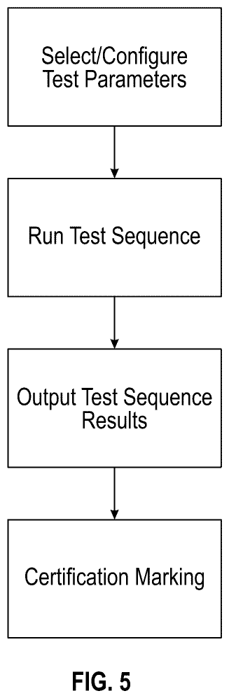

Testing and certification of swivels such as that shown in FIG. 1 may be accomplished using the methods disclosed herein. Although the methods disclosed herein are directed to testing and certification of swivels, testing may also be applicable to various machine components which operate under similar mechanical principles to determine suitability of the component for service based upon the components' response to such testing. Such methods may be practiced using the devices previously described herein as test beds or on other suitable devices. In one example method illustrated in FIG. 5 the test parameters are selected for the swivel to be tested. The testing parameters may include a variety of different aspects including one or more of pull force to be applied to the swivel, pull/test duration, applied rotational force duration, rotational speed (in revolutions per minute, for example), and/or rotational direction (e.g., clockwise, counterclockwise, or bi-directional). Parameters may be selected individually on a case-by-case basis or in other examples parameters may be grouped into predetermined test settings packages and/or user-defined test settings packages. Such predetermined test settings packages may be sorted by characteristics of the swivels being tested. Such characteristics may include manufacturer, rated load, age/hours of use, lifecycle rating, field of use (e.g., cable pulling or lifting rigging; underground pulling or overhead pulling), or other suitable characteristics.

Pull force (tension) for a particular testing sequence in one example will be the rated load limit (“rated load”) of the swivel being tested. In some examples, a swivel will have one rated load limit for underground cable pulling and a second rated load limit for overhead cable pulling. In such cases testing may be done at the higher of the two rated load limits, although the present disclosure is not thereby limited. In other examples, testing may be done at the lower of the two rated load limits with final certification noting that the tested swivel was only certified at the lower load limit and/or certified only for certain uses (e.g., certified only for underground cable pulling). In yet other examples, applied loads may vary during a testing sequence between higher and lower loads with the highest applied load being the rated load limit of the swivel being tested. In this particular example, tensile forces may incrementally increase and/or incrementally decrease for a period of time during the testing. In still other examples the sequence may subject a swivel to loads greater than the rated load for one or more periods of time before reducing the tension applied. Pull load duration may vary as desired, but is typically measured in minutes.

Rotational speed and/or direction for a particular testing sequence may be set at any number of revolutions per minute as desired. In some examples, a swivel may be tested at one rate of RPM for underground cable pulling and a second rate of RPM for overhead cable pulling. In such cases testing may be done at the higher of the two rates. In other examples, testing may be done at the lower of the two rates with final certification noting that the tested swivel was only certified at the lower rate of RPM. In still other examples, testing may include a rotational force which allows the swivel to rotate at a constant rate. In still other examples, the rate of revolutions for a swivel test may vary during the testing procedure such that an average RPM is set as a parameter and the testing sequence includes periods of higher and lower rotation. The direction of rotation during a testing sequence may be set as either clockwise, counterclockwise, or both (bi-directional) as desired. During the testing process, swivels may include at least one rotational testing cycle, which will be discussed further subsequently.

Once the testing parameters have been selected (either individually or as a package of testing parameters) a swivel is loaded into a testing apparatus and the testing sequence initiated. The testing sequence is then performed according to the selected parameters. Optionally, real time data may be generated by one or more sensors on the testing apparatus, the data collected, stored, and/or transmitted to an output device such as a display screen, printer, or a separate device such as a computer or mobile device. Collected testing data may include one or more of pull force, system pressure, applied RPM, torque required to turn the swivel being tested, rotational position of the swivel relative to the starting orientation, load/RPM of the test bed motor(s) and/or pumps, status of certain variables at a point of swivel failure, and other desired variables or status information of the system. In one example, a torque input may be received from a torque transducer coupled to a swivel. Suitability of the swivel for service may then be determined by comparing a torque indicated by the torque input to a predetermined torque threshold, and a test signal, such as pass or fail, may then be provided based upon the comparison. While the present description discusses a pass or fail test signal, other test signals are within the scope of the present description, including, but not limited to indeterminate, incomplete, error, and still others.

Typically a swivel will be considered as passing a test if it continues to rotate during the entirety of periods when rotational force is applied regardless of any applied tension load. A swivel which ceases rotation, rotates irregularly, or requires torque to rotate which exceeds a predetermined threshold when a rotational force is applied will be considered to have failed. As previously discussed, a swivel which fails to properly rotate when subjected to tension loads can be dangerous when pulling heavy cable over long distances by subjecting the cable to torque potentially resulting in catastrophic failure of the cable and/or the swivel.

A test report may be generated after a testing sequence has been completed for a particular swivel. Such reports may include objective criteria, subjective criteria, or both. For example, one or more of a generic indication of pass/fail if any one tested aspect of a swivel fails, a more specific indication of pass/fail for particular aspects of a testing sequence (e.g., pass tension load test, fail rotational load test), peak rotational speed achieved, peak tension load applied, peak torque applied, swivel gap width before, after, and during testing, noises observed during testing (e.g. grinding, squealing, etc.), odors observed during testing, swivel temperature increases detected during testing, wobble/sway observed, hesitation/pauses during rotational testing, and the like. Optionally, a code (alphanumeric, bar code, QR code, and the like) may be etched or otherwise placed on a particular swivel so that an end user might access such test results, or a pass condition versus failed condition, a load rating, a revised load rating, or other information stored in a database for later reference. Such a system would allow users to track a specific swivel's test history over time as well as allowing later purchasers of a used swivel to access test history before they actually use a previously tested swivel in the field. Optionally, such test results may also include recommendations as to limits to be placed on a particular swivel's future use. For example, it might be recommended that a swivel only be used a certain number of times in total, a certain number of times per year/month, that it only be used at loads lower than its original rating, and/or that it be recertified by testing again within a certain time window (e.g., 6 months) and/or after a certain amount of use (e.g., 100 hours of use).

Once a particular swivel has been subjected to a testing sequence one or more certification indicia may be applied to the swivel. If a swivel fails to satisfy one or more aspects of a testing sequence an indicium indicating “failure” may be stamped, etched, engraved, stickered, or otherwise placed on the swivel housing. Optionally, the specific reason(s) for failure may also be indicated. For example, a swivel might pass the tension load aspect of a testing sequence (e.g., it does not fail under tension) but fail the rotational aspect of the testing sequence (e.g., it stops rotating when over a certain tension threshold but begins rotating once it is under that tension threshold). Such a swivel might be marked as “tension load=passed; rotation load=failed. In still other examples, such a swivel might be marked as having conditionally passed a testing sequence. That is, it might be marked as passed for use under the tension threshold where rotation ceased but unsuitable for higher tension loads. As a swivel ages it might be passed for lower and lower tension loads until it ultimately fails for any load no matter how low and must be retired from use. Such downward revision of a swivel's rated tension load might allow for a longer useful life for swivels albeit at lower tension loads as they age.

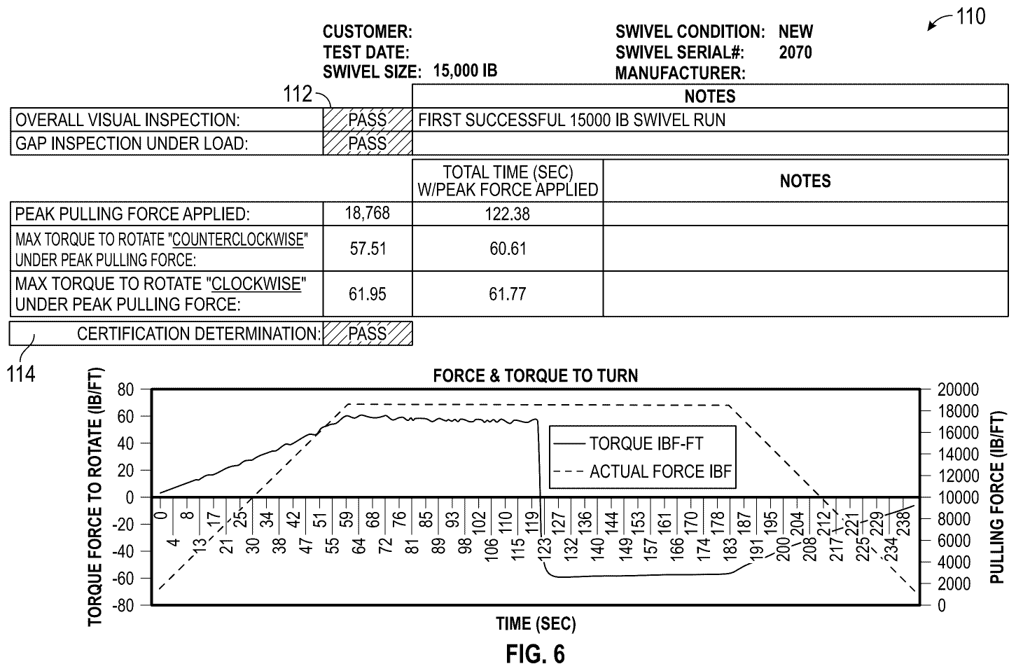

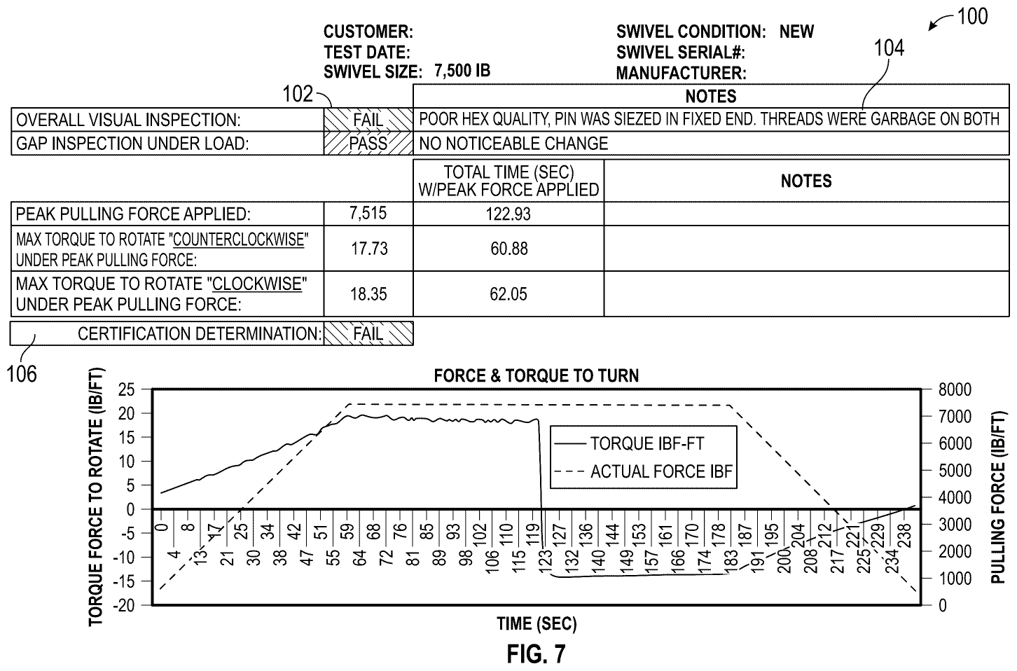

Examples of test reports are shown in FIG. 6-7. FIG. 6 shows a test report 110 for a swivel which passed a test procedure. The report includes information about the swivel including manufacturer, serial number, and rated capacity. The report further includes both subjective information 112 provided by the technician who performed the test procedure as well as objective information 114 concerning the test procedure and test results.

FIG. 7 shows a test report 100 for a swivel which failed a test procedure. The report includes information about the swivel including manufacturer, serial number, and rated capacity. The report further includes both subjective information 102 and comments 104 provided by the technician who performed the test procedure as well as objective information 106 concerning the test procedure and test results. Optionally such test reports may be accessible via indicia marked on the swivel after the testing procedure as previously described.

In one example of a swivel testing and certification procedure according to the disclosed invention a swivel is loaded into a test bed apparatus, testing parameters are selected, and the testing sequence initiated. The testing sequence could be a four-minute process which includes a tension loading sequence, a rotational cycle, and a tension unloading sequence. The term “rotational cycle” as discussed herein refers to a specific period of time during which a swivel being tested undergoes repeated or periodic rotational phases. In this particular example, the testing sequence includes a tension loading sequence, a first rotational sequence, a second rotational sequence, and a tension unloading sequence. As noted above, while the present description discusses a rotational cycle including a “first rotational sequence” and a “second rotational sequence”, alternative tension and rotational sequences are within the scope of the present description. For example, a rotational cycle may additionally include additional rotation sequences, additional tension sequences, or an alternative sequence order.

In the first sequence a tension force is applied to the swivel until a fraction of the rated working load is reached. In one example the fraction of the rated working load is greater than 1%. In a refinement, the fraction of the rated working load is equal to approximately 10% of the stated working load limit. Once a fraction of the rated working load tension load is achieved clockwise rotation of the swivel at a constant rate is initiated. Once the swivel is rotating, tension force is increased from a rated working load that is a fraction of the rated working load capacity to a tension force greater than the rated working load capacity. In one example a tension force greater than the working load capacity may be approximately 125% of the rated working load, although tension forces of 100%, 110%, 150%, for example are within the scope of the present disclosure. Tension force may be increased at a steady rate over the course of a period of time. In one example, the period of time may be approximately 1 minute.

As noted above, the following is an exemplary instance of a rotational cycle, and alternative rotational cycles are contemplated. In the second sequence the swivel is rotated at a constant rate with a tension force greater than the rated working load capacity, for a period of time. In one example, the swivel may be rotated at 10 RPM at 125% load for one minute. In the third sequence clockwise rotation is halted and counterclockwise rotation at a constant rate is initiated and maintained for a period of time. While the present description discusses “clockwise” and “counterclockwise”, testing may also include other types of rotational forces provided the second rotational force varies relative to the first rotational force in at least one direction of rotation or in amplitude. In one example, during the third sequence the swivel may rotate at the same rate with the same force as in the second sequence in a different direction. In another example, the swivel may rotate at 10 RPM for one minute. In the final sequence counterclockwise rotation is maintained as tension unloading is begun. The unload cycle reduces tension from a rated working load that is greater than the rated working load capacity to a fraction of the rated working load at a constant rate for a period of time. When the tension load reaches the fraction of the rated working load counterclockwise rotation of the swivel is stopped. At the end of the testing sequence the tension load is reduced to 0%, the swivel is removed from the test bed, and the results are output to a suitable device and/or screen for review. Following testing, swivels are given an indication of test failure based upon the resistance to continued rotations. It should be appreciated that each sequence occurs over a predetermined period of time, and each sequence may be equal or vary, depending on the testing parameters. It should also be appreciated that variations on these general principles could include application of tensile forces maxing out at the rated load, maxing out at less than the rated load, or potentially multiple different tests to different loads above, below, or at a rated load.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A test platform for testing swivels, comprising:
a testing assembly having a first portion and a second portion connected by at least one support member;
the first portion having a hydraulic cylinder operationally connected to a first swivel attachment point-; and
the second portion having a drive system operationally connected to a second swivel attachment point;
a torque transducer configured to measure torque applied to a swivel coupled to the first swivel attachment point and the second swivel attachment point; and
a controller device configured to detect applied torque and compare the applied torque to a predetermined threshold.

2. The test platform of claim 1 wherein the controller device signals a failure code if the controller detects applied torque above the predetermined threshold.

3. The test platform of claim 2, wherein the controller device further includes a display, a memory, a processor, and an input interface, and controls rotational and tension forces applied to the swivel.

4. The test platform of claim 3 further including a rotatable drive-shaft rotatable via the drive system.

5. The test platform of claim 3 wherein the drive system is electrically operated.

6. The test platform of claim 4, further comprising a universal joint between the rotatable drive shaft and the second swivel attachment point.

7. The test platform of claim 3, wherein the first swivel attachment point and second swivel attachment point are removable.

8. An apparatus for testing components, comprising:
a linear actuator having an attachment point and configured to apply a tension force to a component attached to the linear actuator attachment point;
a rotational actuator having an attachment point and configured to apply a torque to a component attached to the rotational actuator attachment point;
a component operationally attached to the linear actuator attachment point and the rotational actuator attachment point; and
a controller operationally connected to the linear actuator and to the rotational actuator, the controller being configured to determine the tension force applied to the component by the linear actuator and to measure the torque applied to the component by the rotational actuator.

9. The apparatus of claim 8 wherein the controller signals a failure code if the swivel ceases rotating when the rotational actuator is applying torque and the linear actuator is applying tension.

10. The apparatus of claim 9 wherein the controller signals a failure code if the controller detects applied torque above a predetermined threshold.

11. The apparatus of claim 10 wherein the linear actuator includes a hydraulic cylinder and the component includes a swivel.

12. The apparatus of claim 11 further including a drive system operationally connected to a rotatable drive-shaft, the rotatable drive shaft being operationally connected to the rotational actuator attachment point and the drive system being configured to apply rotational and tension forces to the rotatable drive shaft.

13. The apparatus of claim 12 further including a torque transducer disposed between the drive system and the drive shaft configured to measure torque applied by the drive system to the drive-shaft.

14. An apparatus for testing a line pulling swivel, comprising:
a testing assembly having a first portion and a second portion connected by a plurality of support members and defining a testing volume between the first portion, the second portion, and the plurality of support members;
the first portion having a hydraulic cylinder connected to a first connection member;
a first swivel attachment point disposed within the testing volume and connected to the first connection member;
the second portion having a drive system rotatably connected to a rotatable drive shaft;
a second swivel attachment point disposed within the testing volume and connected to the drive shaft.

15. The apparatus of claim 14, further comprising a torque transducer disposed between the drive system and the drive shaft configured to measure a torque applied to the drive-shaft.

16. The apparatus of claim 15, further comprising a controller device configured to control the rotational and tension forces applied to the swivel.

17. The apparatus of claim 16 wherein the controller device signals a failure code if the swivel ceases rotating when the rotational force is applied and the tension force is applied.

18. The apparatus of claim 17 wherein the controller signals a failure code if the controller detects applied torque above a predetermined threshold.

19. The apparatus of claim 18, further comprising a universal joint between the drive shaft and the second swivel attachment point.
